(19) United States
(12) Patent Application Publication
(10) Pub. No.: US 2025/0127602 A1
(43) Pub. Date: Apr. 24, 2025

(54) WATER OUTLET DEVICE WITH DETACHABLE WATER OUTLET TERMINAL

(71) Applicant: Xiamen Solex High-Tech Industries Co., Ltd., Xiamen (CN)

(72) Inventors: Fengde LIN, Xiamen (CN); Donghai CHEN, Xiamen (CN); Xiaolong LIN, Xiamen (CN)

(21) Appl. No.: 18/901,274

(22) Filed: Sep. 30, 2024

(30) Foreign Application Priority Data
Oct. 18, 2023 (CN) 202311344688.0

(51) Int. Cl. A61C 17/02; A61C 17/028

(52) U.S. Cl. CPC A61C 17/0202; A61C 17/028

(57) ABSTRACT

A water outlet device with a detachable water outlet terminal comprises a body, a first water outlet terminal, and a second water outlet terminal. The body has an operating member movably connected to a second connecting opening and configured to alternatively open or close the second connecting opening. The operating member has a locked state and a released state. When a first water outlet terminal is not supplied with water, the operating member is in the released state, and the operating member is configured to be moved relative to the second connecting opening to open the second connecting opening for installation of a second water outlet terminal. When the first water outlet terminal is supplied with the water, the operating member is in the locked state, and the operating member is inhibited from moving relative to the second connecting opening to close the second connecting opening.

### RELATED APPLICATIONS

This application claims priority to Chinese patent application number 202311344688.0, filed on Oct. 18, 2023. Chinese patent application number 202311344688.0 is incorporated herein by reference.

### FIELD OF THE DISCLOSURE

The present disclosure relates to a water outlet device, in particular to a water outlet device with a shower.

### BACKGROUND OF THE DISCLOSURE

There is a gingival sulcus approximately 2 millimeters deep at a junction between a tooth and gums, which is a primary pathway for bacteria to enter the roots of the teeth. It is prone to accumulating dirt and debris, making it the most susceptible area for tooth and gum diseases.

The gingival sulcus and the spaces between teeth are the two most difficult areas to clean. Studies have shown that “up to 40% of tooth surfaces cannot be cleaned with a toothbrush.” Although dental floss (or toothpicks) can remove debris from the tooth surface, microscopically, the uneven surfaces of the teeth remain unclean. Bacteria only need a very thin layer of nutrient film to grow, and the harmful effects of residual dirt film still partially exist.

From a theoretical standpoint, a powerful water jet that can penetrate crevices and holes is the ideal method for oral cleaning. Research from relevant institutions indicates that a pressurized water jet can penetrate 50-90% of the depth of the gingival sulcus. The pressurized water jet can not only clean various crevices, holes, and uneven surfaces but can also achieve a microscopic level of thorough “cleaning” rather than just a macroscopic level of rough “removal.” In addition to its function of cleaning teeth and the oral cavity, the water jet in an oral irrigator also massages the gums, promoting blood circulation and enhancing the local tissue's resistance to disease, while also eliminating bad breath caused by poor oral hygiene.

Food debris stuck between the teeth is not only uncomfortable and harbors bacteria but also provides nutrients for dental plaque. If not promptly removed, dental plaque can easily calcify and turn into “tartar” accumulating at the root of the teeth, compressing and irritating the periodontal environment, and leading to gum recession.

An oral irrigator is an essential hygiene product for many households. Its cleaning function primarily relies on the impact force of a high-speed water jet ejected under certain pressure. However, the electric oral irrigators on the market are expensive and require charging or batteries. Recently, a new type of faucet with an integrated oral irrigator has appeared on the market, which can achieve both conventional water flow and oral irrigation functions. However, with the existing faucets with integrated oral irrigators, the nozzle can be installed whether the water is turned on or off. This design can lead to misoperation when installing the nozzle with the water turned on, as it may cause the water to flow out accidentally.

### BRIEF SUMMARY OF THE DISCLOSURE

The technical problem to be solved by the present disclosure is to provide a water outlet device with a detachable water outlet terminal. When a shower water function is used, an operating member cannot be moved to a position where a second connecting opening is open, thereby preventing misoperation.

In order to solve the above technical problems, the present disclosure provides a water outlet device with a detachable water outlet terminal, comprising: a body, a first water outlet terminal, and a second water outlet terminal. The body has a water inlet port, a first connecting opening, and a second connecting opening, and the water inlet port is in communication with a water source. The first water outlet terminal is connected to the first connecting opening, and the second water outlet terminal is detachably connected to the second connecting opening.

The body further has an operating member movably connected to the second connecting opening and configured to alternatively open or close the second connecting opening, and the operating member has a locked state and a released state. When the first water outlet terminal is not supplied with water, the operating member is in the released state, and the operating member is configured to be moved relative to the second connecting opening to open the second connecting opening for installation of the second water outlet terminal. When the first water outlet terminal is supplied with the water, the operating member is in the locked state, and the operating member is inhibited from moving relative to the second connecting opening to close the second connecting opening.

In a preferred embodiment, the body comprises a first water outlet channel, a second water outlet channel, and a switching member enabling the water inlet port to be alternatively in communication with the first water outlet channel or the second water outlet channel.

The water outlet device comprises a position-limiting member, and the second connecting opening is in communication with the second water outlet channel.

When the water is turned on and the operating member is in a position where the second connecting opening is closed, the position-limiting member is moved from an initial position to a position-limiting position, and the position-limiting member is configured to lock the switching member at a position where the first water outlet channel is in communication with the water inlet port and where the switching member is interlocked with the operating member to lock the operating member at the position where the second connecting opening is closed.

In a preferred embodiment, when the water is turned off and the operating member is moved from the position where the second connecting opening is closed to a position where the second connecting opening is open, the operating member drives the switching member to move to a position where the second water outlet channel is in communication with the water inlet port, and the switching member is interlocked with the position-limiting member to enable the position-limiting member to be locked in the initial position.

In a preferred embodiment, when the position-limiting member moves from the initial position to the position-limiting position, a first spring is compressed to accumulate a first elastic resetting force. When the switching member moves to the position where the second water outlet channel is in communication with the water inlet port, a second spring is compressed by the switching member to accumulate a second elastic resetting force.

In a preferred embodiment, the operating member is a toggle button, the switching member is a switching shaft, and the operating member is connected to the switching member through a direction-changing member to change a rotation of the toggle button to axial movement of the switching shaft.

In a preferred embodiment, the direction-changing member is a protrusion disposed on the toggle button and a slider disposed between the toggle button and the switching shaft.

In a preferred embodiment, when the water is turned on and the operating member is at a position where the second connecting opening is closed, the position-limiting member has translational freedom due to water pressure to move from the initial position to the position-limiting position. The position-limiting member has a chamber for the switching member to enter. When the position-limiting member is in the initial position, the chamber is aligned with the switching member. When the position-limiting member is in the position-limiting position, the chamber is misaligned with the switching member.

In a preferred embodiment, the switching member comprises a water passage in communication with the water inlet port and a water outlet port enabling the water passage to be alternatively in communication with the first water outlet channel or the second water outlet channel. When the operating member is at the position where the second connecting opening is closed, the switching member is moved to the position where the first water outlet channel is in communication with the water inlet port.

In a preferred embodiment, the position-limiting member is disposed at a junction of the water passage and the water inlet port. When the position-limiting member is in the position-limiting position, a water passage area of the junction of the water passage and the water inlet port is S1. When the position-limiting member is in the initial position, the switching member enters a chamber of the position-limiting member to enable the position-limiting member to be maintained in the initial position, and the water passage area of the junction of the water passage and the water inlet port is S2. The S1> the S2.

In a preferred embodiment, the water outlet device comprises a water stopping assembly configured to enable the water inlet port to be connected to or disconnected from the switching member.

The water stopping assembly comprises a button, a valve core, and a third spring, and the button is configured to drive the valve core from an open position to a closed position. When in the closed position, the third spring is compressed to accumulate a third elastic resetting force.

In a preferred embodiment, the second connecting opening located at a front end of the body in an axial direction of the body, and the second water outlet terminal is an oral irrigator nozzle. The first connecting opening is perpendicular to the axial direction of the body. The first water outlet terminal comprises a bubble water outlet port, a plurality of shower water outlet ports arranged concentrically relative to the bubble water outlet port, and a knob configured to alternatively switch between the bubble water outlet port to discharge bubble water or the plurality of shower water outlet ports to discharge shower water.

Compared with the existing techniques, the technical solution has the following advantages.
1. The present disclosure provides the water outlet device with the detachable water outlet terminal. Through cooperation of the position-limiting member, the operating member, and the switching member, when water is turned on, the position-limiting member moves to the position-limiting position due to the water pressure. At this time, the position-limiting member and the operating member are interlocked with each other to enable the switching member to be locked in the position where the first water outlet channel is in communication with the water inlet port, and the switching member also enables the operating member to be locked in the position where the second connecting opening is closed. This prevents the user from opening the second connecting opening using the operating member, and the oral irrigator nozzle cannot be inserted into the second connecting opening while the water is turned on. Therefore, misoperation of opening the second connecting opening to spray water can be avoided. When the water is turned off and the water pressure disappears, the position-limiting member is driven back to the initial position by the first elastic resetting force of the first spring, and an interlocked connection between the switching member and the position-limiting member and an interlocked connection between the switching member and the operating member are released. At this time, the user can open the second connecting opening using the operating member and move the switching member to the position where the second water outlet channel is in communication with the water inlet port. After inserting the oral irrigator nozzle, the oral irrigation function can be used normally. Additionally, when the switching member moves to the position where the second water outlet channel is in communication with the water inlet port, the switching member is once again interlocked with the position-limiting member to lock the position-limiting member in the initial position, preventing the position-limiting member from moving to the position-limiting position when the water is turned on again.
2. The present disclosure provides the water outlet device with the detachable water outlet terminal. When the position-limiting member is in the initial position, a connection area between the water passage of the switching shaft and the water inlet port is reduced, thereby reducing a flow rate into the second water outlet channel, which meets flow requirements for using the oral irrigation function.
3. The present disclosure provides the water outlet device with the detachable water outlet terminal, which allows water stoppage using the water stopping assembly when using the shower function or oral irrigation function, making it convenient to use.
4. The present disclosure provides the water outlet device with the detachable water outlet terminal. When the switching member moves to the position where the second water outlet channel is in communication with the water inlet port, the second spring is compressed by the switching member. After the user removes the oral irrigator nozzle, the switching member returns to its original position due to the second spring, thereby driving the operating member to reset and close the second connecting opening.

### BRIEF DESCRIPTION OF THE DRAWINGS

FIG. 1 is a perspective view in a preferred embodiment of the present disclosure.

FIG. 2 is a cross-sectional view in the preferred embodiment of the present disclosure.

FIG. 3 is an exploded view in the preferred embodiment of the present disclosure.

FIG. 4 is a cross-sectional view in the preferred embodiment of the present disclosure, when water is stopped and an operating member is in a position where a connecting opening is closed.

FIG. 5 is a cross-sectional view in the preferred embodiment of the present disclosure, when the water is turned on and the operating member is in the position where the connecting opening is closed.

FIG. 6 is a cross-sectional view in the preferred embodiment of the present disclosure, when the water is turned off and the operating member is in a position where the connecting opening is open.

FIG. 7 is a schematic diagram in the preferred embodiment of the present disclosure, when an oral irrigator nozzle is inserted into a water outlet device in a state shown in FIG. 6 to enable a water inlet port to be switched to be in communication with a second water outlet channel.

FIG. 8 is a schematic diagram in the preferred embodiment of the present disclosure, showing that the operating member cooperates with a switching member though a direction-changing member.

FIG. 9 is a schematic diagram showing forces acting on a water stopping assembly in a water flow state in the preferred embodiment of the present disclosure.

FIG. 10 is a schematic diagram showing the forces acting on the water stopping assembly in a water stopped state in the preferred embodiment of the present disclosure.

FIG. 11 is an enlarged view of part A in FIG. 10.

FIG. 12 is a cross-sectional view in the preferred embodiment of the present disclosure, when the water is turned on and the operating member is in the position where the connecting opening is closed similar to FIG. 5, but including an encircled part B.

FIG. 13 is an enlarged view of the encircled part B in FIG. 12.

FIG. 14 is a schematic diagram showing forces acting on a water stopping assembly in a water flow state in the preferred embodiment of the present disclosure similar to FIG. 9, but including an encircled part C.

FIG. 15 is an enlarged view of the encircled part C in FIG. 14.

### DETAILED DESCRIPTION OF THE EMBODIMENTS

The following will clearly and completely describe the technical solutions in the embodiments of the present disclosure with reference to the accompanying drawings. Obviously, the described embodiments are only a portion of the embodiments of the present disclosure, and not all of the embodiments. Based on the embodiments of the present disclosure, all other embodiments obtained by those of ordinary skill in the art without creative work fall within the protection scope of the present disclosure.

In the description of the present disclosure, it should be noted that the terms “upper”, “lower”, “inner”, “outer”, “top end”, “bottom end”, etc. indicate the orientation or positional relationship based on the orientation shown in the drawings. The positional relationship is only for the convenience of describing the present disclosure and simplifying the description, rather than indicating or implying that the referenced device or element must have a specific orientation, be constructed, and be operated in a specific orientation. Therefore, the positional relationship should not be understood as a limitation of the present disclosure. In addition, the terms “first” and “second” are only used for descriptive purposes and should not be understood as indicating or implying relative importance.

In the description of the present disclosure, it should be noted that the terms “installed”, “provided with”, “sleeved/connected”, “connected”, etc., should be understood broadly. For example, “connected” can be a wall hanging connection, a detachable connection, or an integral connection, a mechanical connection, an electrical connection, a direct connection, or an indirect connection through an intermediate medium, and it can be a connection in two members. For those of ordinary skill in the art, the specific meaning of the above terms in the present disclosure can be understood under specific conditions.

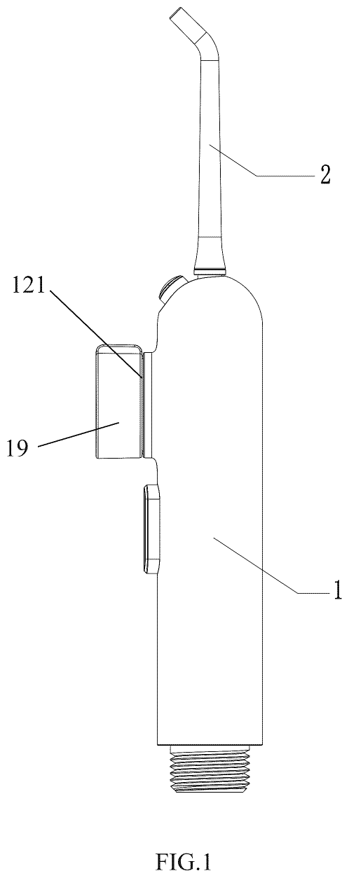

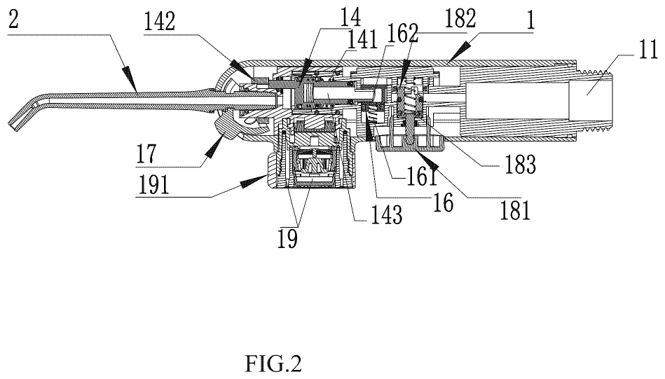

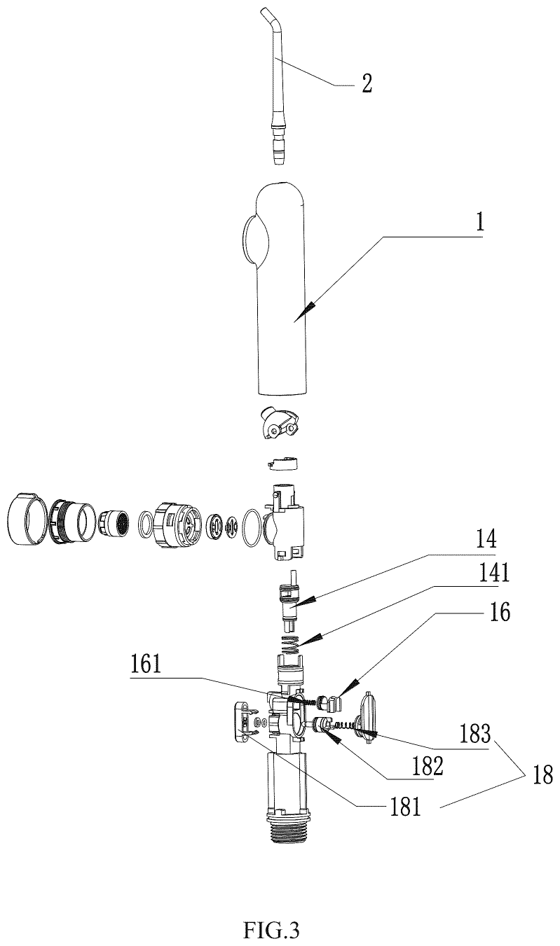

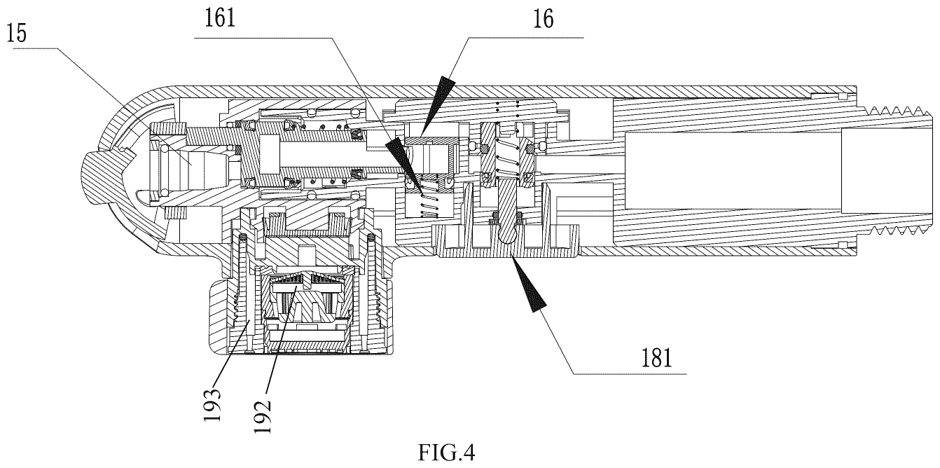

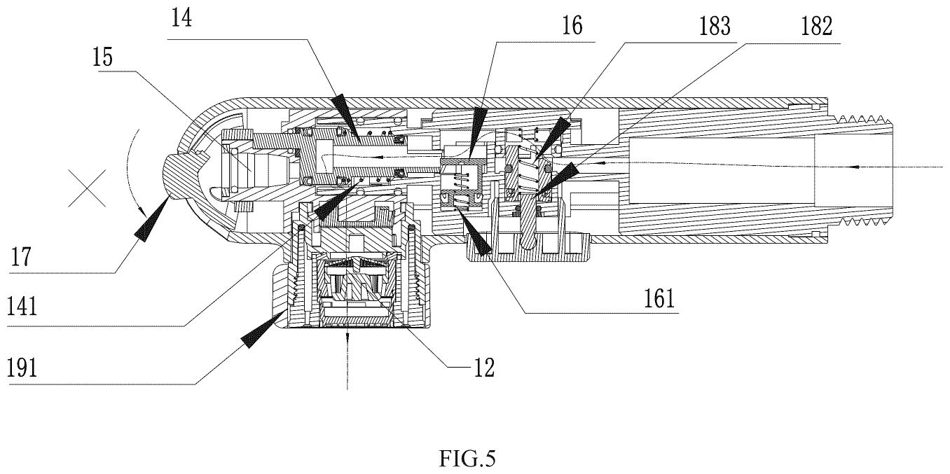

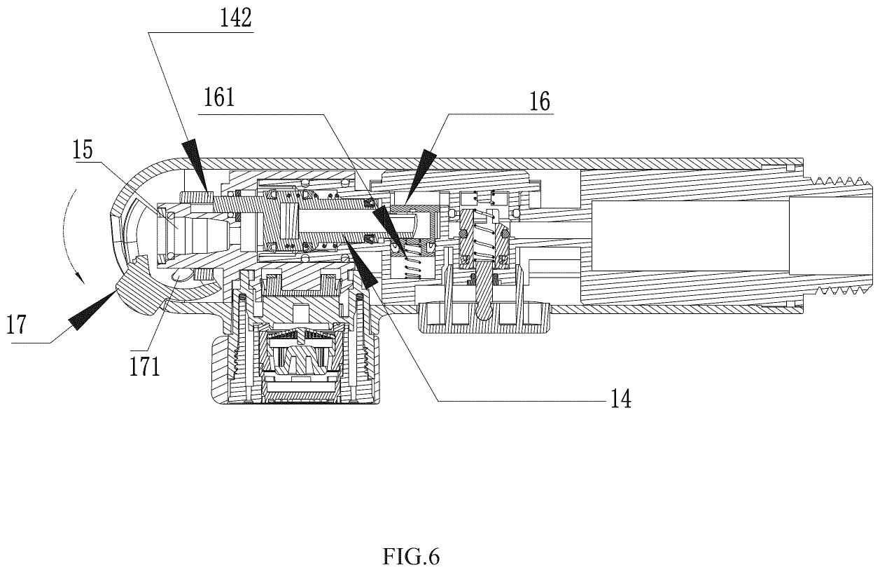

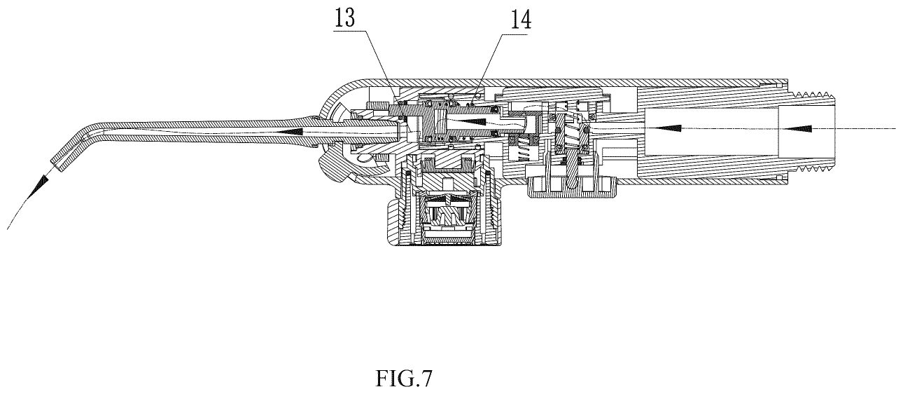

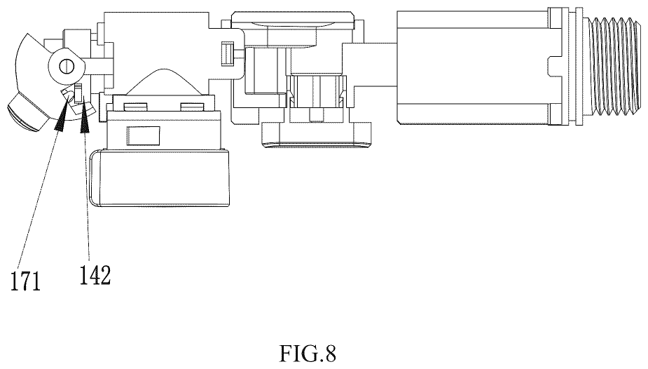

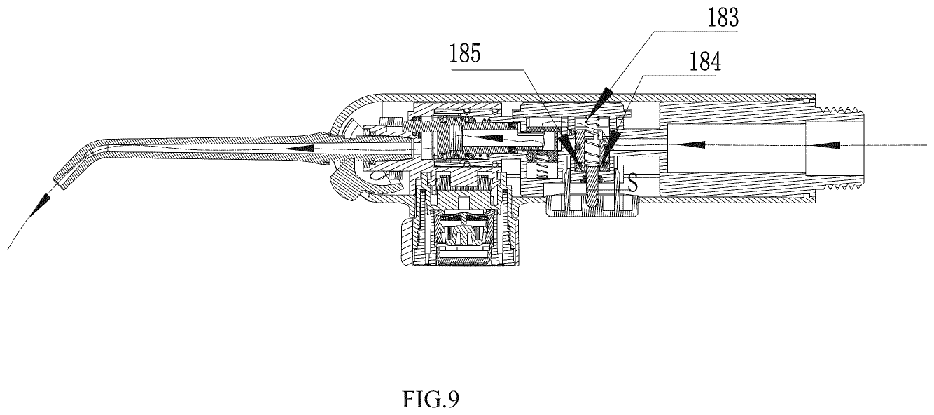

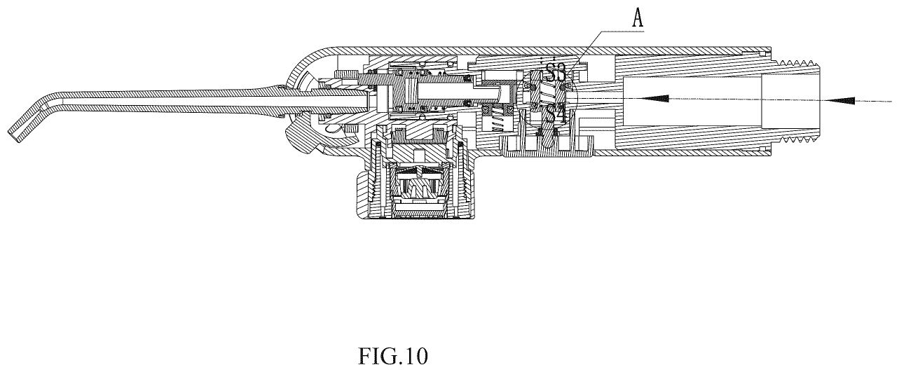

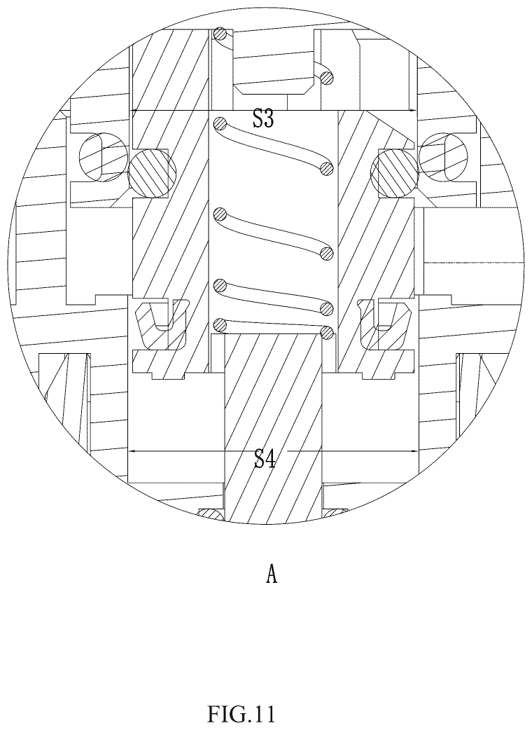

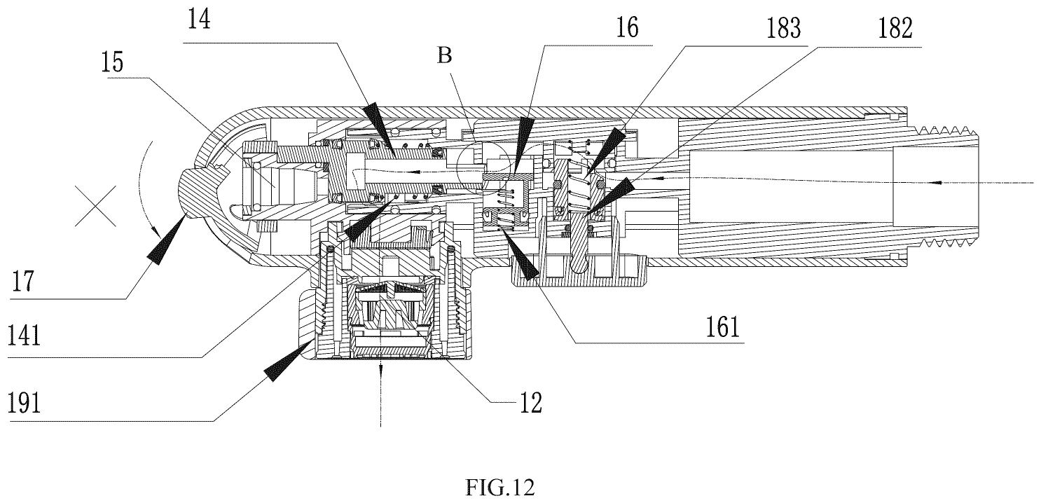

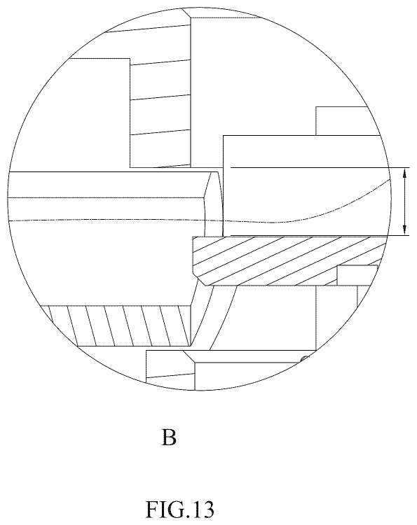

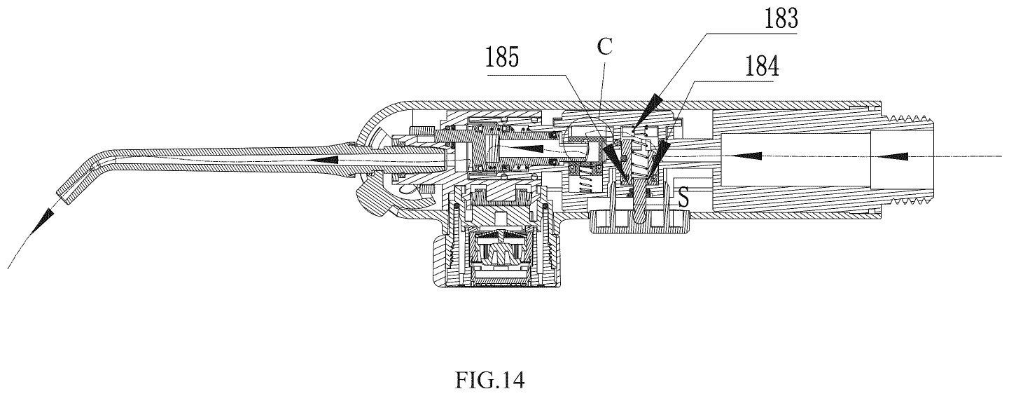

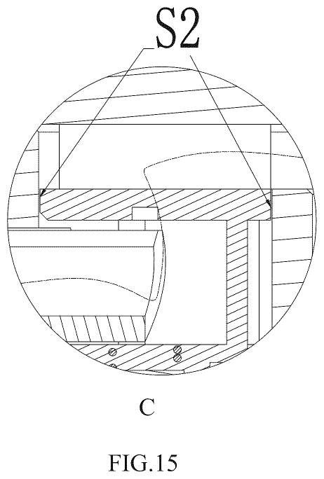

Referring to FIGS. 1-15, this embodiment provides a showerhead with an oral irrigator function, comprising a showerhead body 1 and an oral irrigator nozzle 2. The showerhead body 1 comprises a water inlet port 11, a first water outlet channel 12, a second water outlet channel 13, and a switching member 14 enabling the water inlet port 11 to be alternatively in communication with the first water outlet channel 12 or the second water outlet channel 13.

The showerhead body 1 further comprises a connecting opening 15 configured to be connected to the oral irrigator nozzle 2, an operating member 17 configured to open or close the connecting opening 15, and a position-limiting member 16. The connecting opening 15 is in communication with the second water outlet channel 13.

When water is turned on and the operating member 17 is in a position where the connecting opening 15 is closed, the position-limiting member 16 is moved from an initial position to a position-limiting position. The position-limiting member 16, when in the position-limiting position, is configured to lock the switching member 14 in a position where the first water outlet channel 12 is in communication with the water inlet port 11 and where the switching member 14 is interlocked with the operating member 17 to lock the operating member 17 in the position where the connecting opening 15 is closed. Thereby the operating member 17 can be maintained in a locked state.

When the showerhead having the oral irrigator function is in a state of the water being turned off and the operating member 17 located in the position where the connecting opening 15 is closed, the water can be turned on by the user, and the position-limiting member 16 will be moved to the position-limiting position due to water pressure. At this time, the position-limiting member 16 and the switching member 14 will be interlocked with each other, the switching member 14 is locked in the position where the first water outlet channel 12 is in communication with the water inlet port 11, and the operating member 17 is locked in the position where the connecting opening 15 is closed by the switching member 14. In this way, when the water is turned on, the connecting opening 15 cannot be opened by the user using the operating member 17 and the oral irrigator nozzle 2 cannot be inserted into the connecting opening 15, preventing the water from mistakenly discharging from the connecting opening 15 during operation.

When the water is turned off and the position-limiting member 16 is reset to the initial position, an interlocked connection between the switching member 14 and the position-limiting member 16 is released, and the operating member 17 is in a released state. The user can then rotate the operating member 17 from the position where the connecting opening 15 is closed to a position where the connecting opening 15 is open, and the operating member 17 drives the switching member 14 to move to a position where the second water outlet channel 13 is in communication with the water inlet port 11.

When the position-limiting member 16 is moved from the initial position to the position-limiting position, a first spring 161 is compressed by the position-limiting member 16 to accumulate an elastic resetting force. Thus, when the water is turned off and the water pressure disappears, the position-limiting member 16 is driven back to the initial position by the elastic resetting force of the first spring 161, and the interlocked connection between the switching member 14 and the position-limiting member 16 and an interlocked connection between the switching member 14 and the operating member 17 are released. Therefore, when the water is turned off, the user can open the connecting opening 15 using the operating member 17, and the user can, using the operating member 17, drive the switching member 14 to move to the position where the second water outlet channel 13 is in communication with the water inlet port 11, allowing normal use of the oral irrigator function after the oral irrigator nozzle 2 is inserted into the connecting opening 15.

In a preferred embodiment, when the switching member 14 is moved to the position where the second water outlet channel 13 is in communication with the water inlet port 11, the switching member 14 can be interlocked again with the position-limiting member 16 to enable the position-limiting member 16 to be locked in the initial position, thereby preventing the position-limiting member 16 from being moved back to the position-limiting position after the water is turned on.

To achieve the switching member 14 being interlocked again with the position-limiting member 16 to enable the position-limiting member 16 to be locked in the initial position when the switching member 14 is moved to the position where the second water outlet channel 13 is in communication with the water inlet port 11, in this embodiment, the switching member 14 is a switching shaft, and a moving direction of the switching member 14 is along an axial direction of the switching member 14. A moving direction of the position-limiting member 16 driven by the water pressure is perpendicular to the axial direction of the switching member 14, and the position-limiting member 16 has a chamber 162 for the switching member 14 to enter. When the position-limiting member 16 is in the initial position, the chamber 162 is aligned with the switching member 14, allowing the switching member 14 to move in the axial direction of the switching member 14 to enter the chamber 162 to enable the switching member 14 to move to the position where the second water outlet channel 13 is in communication with the water inlet port 11, so that the switching member 14 is interlocked with the position-limiting member 16 to enable the position-limiting member 16 to be maintained in the initial position. When the position-limiting member 16 is in the position-limiting position, the chamber 162 is misaligned with the switching member 14. At this time, the switching member 14 is interlocked with the position-limiting member 16, and the switching member 14 is locked in the position where the first water outlet channel 12 is in communication with the water inlet port 11.

After using the oral irrigator function, the user needs to remove the oral irrigator nozzle 2 for hygienic storage. If the user still has to manually rotate the operating member 17 back to close the connecting opening 15, it is quite inconvenient. Therefore, it is necessary to enable the operating member 17 to automatically close the connecting opening 15 by simply removing the oral irrigator nozzle 2, avoiding a risk of contaminating the connecting opening 15 due to forgetfulness. To this end, when the switching member 14 is moved to the position where the second water outlet channel 13 is in communication with the water inlet port 11, a second spring 141 is compressed by the switching member 14 to accumulate an elastic resetting force. Additionally, the operating member 17 is a toggle button, and the switching member 14 is the switching shaft. The operating member 17 is connected to the switching member 14 through a direction-changing member to change a rotation of the toggle button to axial movement of the switching shaft. Because the operating member 17 is locked in the position where the connecting opening 15 is open after the oral irrigator nozzle 2 is inserted into the connecting opening 15, the second spring 141 cannot drive the switching member 14 to be reset. However, once the user removes the oral irrigator nozzle 2, the second spring 141 can release the elastic resetting force to drive the switching member 14 to be reset, and after the switching member 14 is reset, the switching member 14 can drive the operating member 17 back to the position where the connecting opening 15 is closed through the direction-changing member.

Specifically, in this embodiment, the direction-changing member is a protrusion 171 disposed on the toggle button and a slider 142 disposed between the toggle button and the switching shaft. When the toggle button is rotated, the slider 142 is pressed by the protrusion 171 during the rotation of the toggle button, thereby driving the switching shaft to move along the axial direction of the switching member, achieving a purpose of moving the switching shaft by toggling the toggle button. When the toggle button is released, the switching shaft is driven by the second spring 141 to move, and the protrusion 171 is pressed by the slider 142 during the axial movement of the switching shaft, thereby driving the toggle button to rotate back to the position where the connecting opening 15 is closed.

Because water flow requirements differ significantly between a shower water function and the oral irrigator function, with the oral irrigator function requiring less water flow and the shower water function requiring more water flow, it is necessary to reduce a water outlet flow when using the oral irrigator function. To this end, the switching member 14 comprises a water passage 143 in communication with the water inlet port 11 and a water outlet port enabling the water passage 143 to be alternatively in communication with the first water outlet channel 12 or the second water outlet channel 13. The position-limiting member 16 is disposed at a junction of the water passage 143 and the water inlet port 11. When the position-limiting member 16 is in the position-limiting position, a water passage area of the junction of the water passage 143 and the water inlet port 11 is S1. When the position-limiting member 16 is in the initial position, the switching member 14 enters the chamber 162 to enable the position-limiting member 16 to be maintained in the initial position, and the water passage area of the junction of the water passage 143 and the water inlet port 11 is S2. The S1> the S2. This design utilizes positional changes of the switching member 14 and the position-limiting member 16 in their two cooperative states to change the water passage area of the junction of the water passage 143 and the water inlet port 11, allowing for dynamic adjustment of the water outlet flow to suit the corresponding function and make the showerhead more user-friendly.

To further facilitate user operation, this embodiment further comprises a water stopping assembly 18, and the water stopping assembly 18 is configured to enable the water inlet port 11 to alternatively be connected to or disconnected from the switching member 14. This enables temporary water stoppage during operation by manipulating the water stopping assembly 18.

In this embodiment, the water stopping assembly 18 comprises a button 181, a valve core 182, and a third spring 183. The button 181 is configured to drive the valve core 182 to move from an open position to a closed position, and when in the closed position, the third spring 183 is compressed to accumulate an elastic resetting force. To reduce a force required by the user for the water stopping operation, in this embodiment, the valve core 182 comprises a water passage hole 184, and a space 185 in communication with the water passage hole 184 is formed between the valve core 182 and the showerhead body 1. When the water is turned on, the water fills the space 185 through the water passage hole 184, and the valve core 182 only experiences downward water pressure over an area S. Pressing the button 181 requires overcoming a pressure generated by this portion of the water pressure (i.e., the downward water pressure over the area S) and the elastic resetting force generated by compressing the third spring 183. At the same time, the valve core 182 experiences the downward pressure from the water pressure over area S, which helps the valve core 182 be reset to an initial position after releasing the button 181. Therefore a value of the elastic resetting force of the third spring 183 can be slightly smaller, and a switching force for the water stopping operation can be light under no load. When the water is stopped, an area S3 on the valve core 182 is equal to an area S4 on the valve core 182, and the valve core 182 is maintained in a water pressure balanced state, so that the user only needs to overcome the elastic resetting force of the third spring 183 at a moment of the button 181 being pressed. After the button 181 is pressed for a long time, the button 181 must overcome both the elastic resetting force of the third spring 183 and the water pressure exerted over area S. Finally, in this embodiment, the connecting opening 15 is a second connecting opening located at a front end of the showerhead body 1 in an axial direction of the showerhead body 1, and the connecting opening 15 is connected to a second water outlet terminal, namely the oral irrigator nozzle 2. The showerhead body 1 further comprises a first connecting opening 121 connected to the first water outlet channel 12, and the first connecting opening 121 is perpendicular to the axial direction of the showerhead body 1 and is connected to a first water outlet terminal 19. The first water outlet terminal 19 comprises a bubble water outlet port 192, a plurality of shower water outlet ports 193 arranged concentrically, and a knob 191 configured to alternatively switch between the bubble water outlet port 192 to discharge bubble water or the plurality of shower water outlet ports 193 to discharge shower water. The structures for switching between the shower water and the bubble water are existing techniques, and this embodiment does not elaborate further on the structures.

The aforementioned embodiments are merely some embodiments of the present disclosure, and the scope of the disclosure is not limited thereto. Thus, it is intended that the present disclosure cover non-substantive modifications of the present disclosure provided they are made based on the concept within the technical scope disclosed in the present disclosure by any technical person skilled in the art.

What is claimed is:

1. A water outlet device with a detachable water outlet terminal, comprising:
a body,
a first water outlet terminal, and
a second water outlet terminal, wherein:
the body has a water inlet port, a first connecting opening, and a second connecting opening,
the water inlet port is in communication with a water source,
the first water outlet terminal is connected to the first connecting opening,
the second water outlet terminal is detachably connected to the second connecting opening,
the body further has an operating member movably connected to the second connecting opening and configured to alternatively open or close the second connecting opening,
the operating member has a locked state and a released state,
when the first water outlet terminal is not supplied with water:
the operating member is in the released state, and
the operating member is configured to be moved relative to the second connecting opening to open the second connecting opening for installation of the second water outlet terminal, and
when the first water outlet terminal is supplied with the water:
the operating member is in the locked state, and
the operating member is inhibited from moving relative to the second connecting opening to close the second connecting opening.

2. The water outlet device with the detachable water outlet terminal according to claim 1, wherein:
the body comprises a first water outlet channel, a second water outlet channel, and a switching member enabling the water inlet port to be alternatively in communication with the first water outlet channel or the second water outlet channel,
the water outlet device comprises a position-limiting member,
the second connecting opening is in communication with the second water outlet channel, and
when the water is turned on and the operating member is in a position where the second connecting opening is closed:
the position-limiting member is moved from an initial position to a position-limiting position, and
the position-limiting member is configured to lock the switching member in a position where the first water outlet channel is in communication with the water inlet port and where the switching member is interlocked with the operating member to lock the operating member in the position where the second connecting opening is closed.

3. The water outlet device with the detachable water outlet terminal according to claim 2, wherein:
when the water is turned off and the operating member is moved from the position where the second connecting opening is closed to a position where the second connecting opening is open:
the operating member drives the switching member to move to a position where the second water outlet channel is in communication with the water inlet port, and
the switching member is interlocked with the position-limiting member to enable the position-limiting member to be locked in the initial position.

4. The water outlet device with the detachable water outlet terminal according to claim 3, wherein:
when the position-limiting member moves from the initial position to the position-limiting position, a first spring is compressed to accumulate a first elastic resetting force, and
when the switching member moves to the position where the second water outlet channel is in communication with the water inlet port, a second spring is compressed by the switching member to accumulate a second elastic resetting force.

5. The water outlet device with the detachable water outlet terminal according to claim 2, wherein:
the operating member is a toggle button,
the switching member is a switching shaft, and
the operating member is connected to the switching member through a direction-changing member to change a rotation of the toggle button to axial movement of the switching shaft.

6. The water outlet device with the detachable water outlet terminal according to claim 5, wherein:
the direction-changing member is a protrusion disposed on the toggle button and a slider disposed between the toggle button and the switching shaft.

7. The water outlet device with the detachable water outlet terminal according to claim 2, wherein:
when the water is turned on and the operating member is in the position where the second connecting opening is closed, the position-limiting member has translational freedom due to water pressure to move from the initial position to the position-limiting position,
the position-limiting member has a chamber for the switching member to enter,
when the position-limiting member is in the initial position, the chamber is aligned with the switching member, and
when the position-limiting member is in the position-limiting position, the chamber is misaligned with the switching member.

8. The water outlet device with the detachable water outlet terminal according to claim 4, wherein:
the switching member comprises a water passage in communication with the water inlet port and a water outlet port enabling the water passage to be alternatively in communication with the first water outlet channel or the second water outlet channel, and
when the operating member is in the position where the second connecting opening is closed, the switching member is moved to the position where the first water outlet channel is in communication with the water inlet port.

9. The water outlet device with the detachable water outlet terminal according to claim 8, wherein:
the position-limiting member is disposed at a junction of the water passage and the water inlet port,
when the position-limiting member is in the position-limiting position, a water passage area of the junction of the water passage and the water inlet port is S1,
when the position-limiting member is in the initial position:
the switching member enters a chamber of the position-limiting member to enable the position-limiting member to be maintained in the initial position, and
the water passage area of the junction of the water passage and the water inlet port is S2, and
the S1> the S2.

10. The water outlet device with the detachable water outlet terminal according to claim 1, comprising:
a water stopping assembly configured to enable the water inlet port to be connected to or disconnected from a switching member of the body, wherein:
the water stopping assembly comprises a button, a valve core, and a third spring,
the button is configured to drive the valve core from an open position to a closed position, and
when in the closed position, the third spring is compressed to accumulate a third elastic resetting force.

11. The water outlet device with the detachable water outlet terminal according to claim 2, comprising:
a water stopping assembly configured to enable the water inlet port to be connected to or disconnected from the switching member, wherein:
the water stopping assembly comprises a button, a valve core, and a third spring,
the button is configured to drive the valve core from an open position to a closed position, and
when in the closed position, the third spring is compressed to accumulate a third elastic resetting force.

12. The water outlet device with the detachable water outlet terminal according to claim 3, comprising:
a water stopping assembly configured to enable the water inlet port to be connected to or disconnected from the switching member, wherein:
the water stopping assembly comprises a button, a valve core, and a third spring,
the button is configured to drive the valve core from an open position to a closed position, and
when in the closed position, the third spring is compressed to accumulate a third elastic resetting force.

13. The water outlet device with the detachable water outlet terminal according to claim 4, comprising:
a water stopping assembly configured to enable the water inlet port to be connected to or disconnected from the switching member, wherein:
the water stopping assembly comprises a button, a valve core, and a third spring,
the button is configured to drive the valve core from an open position to a closed position, and
when in the closed position, the third spring is compressed to accumulate a third elastic resetting force.

14. The water outlet device with the detachable water outlet terminal according to claim 5, comprising:
a water stopping assembly configured to enable the water inlet port to be connected to or disconnected from the switching member, wherein:
the water stopping assembly comprises a button, a valve core, and a third spring,
the button is configured to drive the valve core from an open position to a closed position, and
when in the closed position, the third spring is compressed to accumulate a third elastic resetting force.

15. The water outlet device with the detachable water outlet terminal according to claim 6, comprising:
a water stopping assembly configured to enable the water inlet port to be connected to or disconnected from the switching member, wherein:
the water stopping assembly comprises a button, a valve core, and a third spring,
the button is configured to drive the valve core from an open position to a closed position, and
when in the closed position, the third spring is compressed to accumulate a third elastic resetting force.

16. The water outlet device with the detachable water outlet terminal according to claim 7, comprising:
a water stopping assembly configured to enable the water inlet port to be connected to or disconnected from the switching member, wherein:
the water stopping assembly comprises a button, a valve core, and a third spring,
the button is configured to drive the valve core from an open position to a closed position, and
when in the closed position, the third spring is compressed to accumulate a third elastic resetting force.

17. The water outlet device with the detachable water outlet terminal according to claim 8, comprising:
a water stopping assembly configured to enable the water inlet port to be connected to or disconnected from the switching member, wherein:
the water stopping assembly comprises a button, a valve core, and a third spring,
the button is configured to drive the valve core from an open position to a closed position, and
when in the closed position, the third spring is compressed to accumulate a third elastic resetting force.

18. The water outlet device with the detachable water outlet terminal according to claim 9, comprising:
a water stopping assembly configured to enable the water inlet port to be connected to or disconnected from the switching member, wherein:
the water stopping assembly comprises a button, a valve core, and a third spring,
the button is configured to drive the valve core from an open position to a closed position, and
when in the closed position, the third spring is compressed to accumulate a third elastic resetting force.

19. The water outlet device with the detachable water outlet terminal according to claim 1, wherein:
the second connecting opening is located at a front end of the body in an axial direction of the body,
the second water outlet terminal is an oral irrigator nozzle,
the first connecting opening is perpendicular to the axial direction of the body, and
the first water outlet terminal comprises a bubble water outlet port, a plurality of shower water outlet ports arranged concentrically relative to the bubble water outlet port, and a knob configured to alternatively switch between the bubble water outlet port to discharge bubble water and the plurality of shower water outlet ports to discharge shower water.

20. The water outlet device with the detachable water outlet terminal according to claim 2, wherein:
the second connecting opening is located at a front end of the body in an axial direction of the body,
the second water outlet terminal is an oral irrigator nozzle,
the first connecting opening is perpendicular to the axial direction of the body, and
the first water outlet terminal comprises a bubble water outlet port, a plurality of shower water outlet ports arranged concentrically relative to the bubble water outlet port, and a knob configured to alternatively switch between the bubble water outlet port to discharge bubble water and the plurality of shower water outlet ports to discharge shower water.
